(19) United States
(12) Patent Application Publication
(10) Pub. No.: US 2022/0100959 A1
(43) Pub. Date: Mar. 31, 2022

(54) CONVERSATION SUPPORT DEVICE, CONVERSATION SUPPORT SYSTEM, CONVERSATION SUPPORT METHOD, AND STORAGE MEDIUM

(71) Applicant: HONDA MOTOR CO., LTD., Tokyo (JP)

(72) Inventors: Kazuhiro Nakadai, Wako-shi (JP); Naoaki Sumida, Wako-shi (JP); Masaki Nakatsuka, Wako-shi (JP); Yuichi Yoshida, Wako-shi (JP); Takashi Yamauchi, Wako-shi (JP); Kazuya Maura, Hayami-gun (JP); Kyosuke Hineno, Hayami-gun (JP); Syozo Yokoo, Hayami-gun (JP)

(21) Appl. No.: 17/481,336

(22) Filed: Sep. 22, 2021

(30) Foreign Application Priority Data
Sep. 30, 2020 (JP) 2020-164421

(51) Int. Cl. G06F 40/289

(52) U.S. Cl. CPC G06F 40/289

(57) ABSTRACT

A topic analysis portion extracts a word or a phrase of a prescribed topic from utterance text representing utterance content. A search portion searches for reference text related to the topic in a storage portion in which an utterance history including previous utterance text is saved. A display processing portion outputs the utterance text and related information about the reference text in association with each other to a display portion.

### CROSS-REFERENCE TO RELATED APPLICATION

Priority is claimed on Japanese Patent Application No. 2020-164421, filed Sep. 30, 2020, the content of which is incorporated herein by reference.

### BACKGROUND OF THE INVENTION

### Field of the Invention

The present invention relates to a conversation support device, a conversation support system, a conversation support method, and a storage medium.

### Description of Related Art

Conventionally, a conversation support system for supporting a conversation in which people with normal hearing and hearing-impaired people participate in a conversation held by a plurality of people such as a conference has been proposed. The conversation support system performs a speech recognition process on speech uttered in the conversation, converts the speech into text representing utterance content, and displays the text obtained after the conversion on a screen. The conversation support system has a function of saving the text obtained as a speech recognition result as an utterance history (log).

For example, a conference system described in Japanese Unexamined Patent Application, First Publication No. 2019-179480 (hereinafter referred to as Patent Document 1) includes a slave device including a sound collection portion, a text input portion, and a display portion; and a master device connected to the slave device and configured to create minutes using text information obtained in a speech recognition process on speech input from the slave device or text information input from the slave device and share the created minutes with the slave device. In the conference system, when the master device participates in a conversation by text, the master device is controlled such that it makes utterances of other participants have to be waited for and information for making the utterances have to be waited for is transmitted to the slave device.

### SUMMARY OF THE INVENTION

However, participants in a conversation, especially, hearing-impaired people, sometimes cannot fully understand utterance content. On the other hand, the conference system described in Patent Document 1 only has a function of causing the master device to display a button image for issuing an instruction for displaying minutes and an image including an area for displaying the minutes.

An objective of an aspect according to the present invention is to provide a conversation support device, a conversation support system, a conversation support method, and a storage medium capable of allowing participants to easily understand utterance content in a conversation.

In order to achieve the above-described objective by solving the above-described problems, the present invention adopts the following aspects.

(1) According to an aspect of the present invention, there is provided a conversation support device including: a topic analysis portion configured to extract a word or a phrase of a prescribed topic from utterance text representing utterance content; a search portion configured to search for reference text related to the topic in a storage portion in which an utterance history including previous utterance text is saved; and a display processing portion configured to output the utterance text and related information about the reference text in association with each other to a display portion.

(2) In the above-described aspect (1), the display processing portion may extract first element information related to the topic from the utterance text and second element information related to the topic from the reference text and output related information about a change to the display portion when the change from the second element information has occurred in the first element information.

(3) In the above-described aspect (2), the display processing portion may determine an omission or a modification of at least a part of the second element information or a partial addition to the first element information as the change.

(4) In the above-described aspect (3), the display processing portion may determine a change in a prescribed numerical value included in the second element information as the change.

(5) In any one of the above-described aspects (2) to (4), the display processing portion may cause the display portion to display a part in which the change has occurred in a form different from those of the other parts.

(6) In any one of the above-described aspects (1) to (5), the search portion may preferentially select utterance text having a shorter period from a point in time when the utterance text has been acquired to a present point in time as the reference text from the utterance text included in the utterance history.

(7) In any one of the above-described aspects (1) to (6), the storage portion may store the utterance text and a date and time of acquisition of the utterance text in association with each other in the utterance history, and the display processing portion may further output a date and time associated with the reference text.

(8) In any one of the above-described aspects (1) to (7), the conversation support device may include a speech recognition portion configured to acquire the utterance text by performing a speech recognition process on input speech data.

(9) In any one of the above-described aspects (1) to (8), the topic analysis portion may determine the word or the phrase related to the topic conveyed in the utterance text using a topic model representing a word or a phrase related to each topic.

(10) According to an aspect of the present invention, there is provided a conversation support system including: the conversation support device according to any one of the above-described aspects (1) to (9); and a terminal device, wherein the terminal device includes an operation portion configured to receive an operation of a user; and a communication portion configured to transmit the operation to the conversation support device.

(11) According to an aspect of the present invention, there is provided a computer-readable non-transitory storage medium storing a program for causing a computer to function as the conversation support device according to any one of the above-described aspects (1) to (9).

(12) According to an aspect of the present invention, there is provided a conversation support method for use in a conversation support device, the conversation support method including: a topic analysis process of extracting a word or a phrase of a prescribed topic from utterance text representing utterance content; a search process of searching for reference text related to the topic in a storage portion in which an utterance history including previous utterance text is saved; and a display processing process of outputting the utterance text and related information about the reference text in association with each other to a display portion.

According to the aspects of the present invention, participants can be allowed to understand utterance content in a conversation easily.

According to the above-described aspects (1), (10), (11), or (12), the previous reference text having the same topic as the utterance text is searched for and the related information about the reference text found in the search is displayed in association with the utterance text. Because a user can have access to the related information about the reference text having the same topic as the utterance text in comparison with the utterance text, he or she can more easily understand the utterance content conveyed in the utterance text.

According to the above-described aspect (2), the related information about the change from the second element information of the reference text in the first element information of the utterance text is displayed. Thus, the user can easily note a difference of the utterance text from the reference text and can more easily understand the utterance content conveyed in the utterance text with the difference from the reference text.

According to the above-described aspect (3), the related information about the change of an omission or modification of the second element information or addition to the first element information is displayed.

According to the above-described aspect (4), the related information about the change in the prescribed numerical value included in the second element information corresponding to the first element information is displayed.

According to the above-described aspect (5), when a plurality of pieces of utterance text are candidates for the reference text, newer utterance text is adopted as the reference text. Because the related information about the reference text whose utterance content is similar to current utterance text is displayed, the utterance content conveyed in the utterance text can be easily understood.

According to the above-described aspect (6), the date and time of acquisition of the reference text is also displayed together with the related information about the reference text. Thus, it is possible to allow the user to understand the utterance content conveyed in the utterance text in consideration of an elapse of time from the date and time of acquisition of the reference text.

According to the above-described aspect (7), element information displayed in a part where the change has occurred from the reference text is displayed in a form different from those of the other parts. Thus, the user can easily notice a change in the element information.

According to the above-described aspect (8), text representing utterance content according to the user's utterance can be acquired as the utterance text. Utterance text including a speech recognition error and related information about the reference text having the same topic as the utterance content are displayed. Thus, the user can easily notice the occurrence of a speech recognition error in the utterance text.

According to the above-described aspect (9), the topic analysis portion can determine a word or a phrase related to the topic of the utterance content conveyed in the utterance text in a simple process.

### BRIEF DESCRIPTION OF THE DRAWINGS

FIG. 1 is a block diagram showing an example of a configuration of a conversation support system according to the present embodiment.

FIG. 2 is a block diagram showing an example of a functional configuration of a terminal device according to the present embodiment.

FIG. 3 is an explanatory diagram showing a first search example of reference text.

FIG. 4 is a diagram showing a first display example of a display screen.

FIG. 5 is a diagram showing a second display example of the display screen.

FIG. 6 is an explanatory diagram showing a second search example of the reference text.

FIG. 7 is a diagram showing a third display example of the display screen.

FIG. 8 is a diagram showing a fourth display example of the display screen.

FIG. 9 is a diagram showing a first example of word distribution data of a topic model according to the present embodiment.

FIG. 10 is a diagram showing a second example of word distribution data of a topic model according to the present embodiment.

FIG. 11 is a diagram showing an example of topic distribution data of a topic model according to the present embodiment.

FIG. 12 is a flowchart showing an example of a process of displaying utterance text according to the present embodiment.

### DETAILED DESCRIPTION OF THE INVENTION

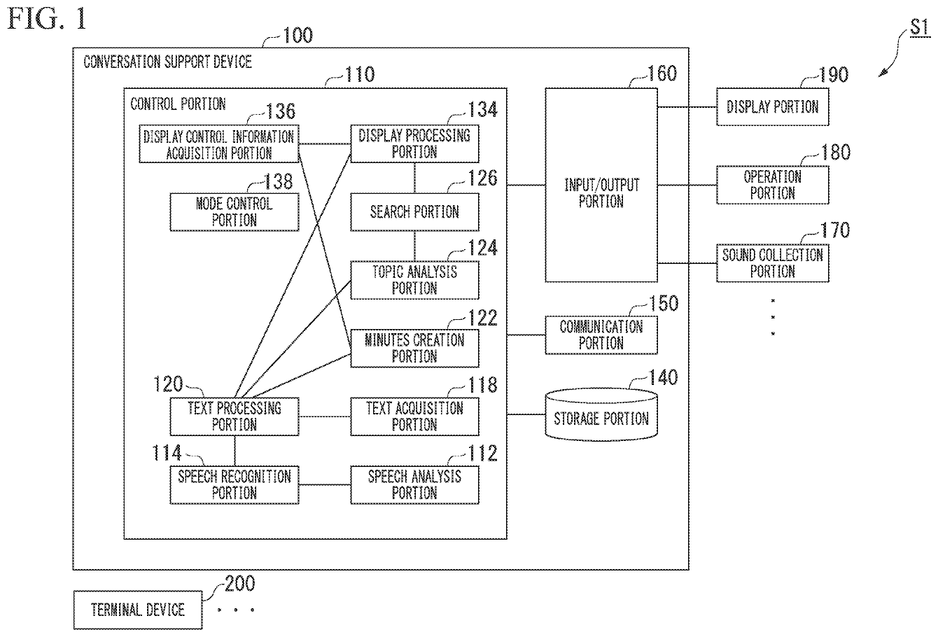

Hereinafter, embodiments of the present invention will be described with reference to the drawings. First, an example of a configuration of a conversation support system S1 according to a present embodiment will be described. FIG. 1 is a block diagram showing the example of the configuration of the conversation support system S1 according to the present embodiment. The conversation support system S1 is configured to include a conversation support device 100 and a terminal device 200.

The conversation support system S1 is used in conversations in which two or more participants participate. The participants may include one or more persons who are disabled in one or both of speaking and listening to speech (hereinafter referred to as “people with disabilities”). A person with a disability may individually operate an operation portion 280 (to be described below) of the terminal device 200 to input utterance text (hereinafter, “second text”) representing utterance content to the conversation support device 100. A person who does not have difficulty in speaking and listening to speech may individually input spoken speech to the conversation support device 100 using a sound collection portion 170 or a device including a sound collection portion (for example, the terminal device 200). The conversation support device 100 performs a known speech recognition process on speech data indicating the input speech and converts utterance content of the speech into utterance text (hereinafter, “first text”) representing the utterance content. The conversation support device 100 causes a display portion 190 to display the utterance text, which has been acquired, each time the utterance text of either the first text obtained in the conversion or the second text obtained from the terminal device 200 is acquired. The people with disabilities can understand the utterance content in a conversation by reading the displayed utterance text (hereinafter, “display text”).

The conversation support device 100 sequentially stores the acquired utterance text in the storage portion 140. The storage portion 140 saves an utterance history in which previous utterance text is accumulated. The conversation support device 100 extracts a word or a phrase of a prescribed topic from the acquired utterance text and searches for reference text which is utterance text related to a topic of the extracted word or phrase from the storage portion 140. The conversation support device 100 causes the display portion 190 to display related information about the reference text obtained in the search in association with the acquired utterance text. On the display portion 190, the utterance text at that point in time is displayed in comparison with the related information about previous reference text having a common topic. Thus, the participants, for example, the people with disabilities, can more easily understand the utterance content conveyed in the utterance text.

The conversation support device 100 attempts to extract element information related to the topic (hereinafter, “first element information”) about a word or a phrase extracted from utterance text and element information (hereinafter, “second element information”) related to the topic from the reference text and causes the display portion 190 to display related information about a change when the change from the second element information has occurred in the first element information. As the related information, the change itself of the element information serving as an element of the topic, guidance information for guiding the user to notice the occurrence of the change, and the like are displayed. Thus, the participants, for example, the people with disabilities, can more easily understand the utterance content conveyed in the utterance text. Examples in which related information, element information, and the like are displayed will be described below.

The conversation support system S1 shown in FIG. 1 includes, but is not limited to, one conversation support device 100 and one terminal device 200. The number of terminal devices 200 may be two or more or may be zero. In the example shown in FIG. 1, the conversation support device 100 and the terminal device 200 have functions as a master device and a slave device, respectively.

In the present application, the term “conversation” means communication between two or more participants and is not limited to communication using speech, and communication using other types of information media such as text is also included. The conversation is not limited to voluntary or arbitrary communication between two or more participants, and may also include communication in a form in which certain participants (for example, moderators) control the utterances of other participants as in conferences, presentations, lectures, and ceremonies. The term “utterance” means communicating intentions using language and includes not only communicating intentions by uttering speech but also communicating intentions using other types of information media such as text.

### (Conversation Support Device)

Next, an example of a configuration of the conversation support device 100 according to the present embodiment will be described. The conversation support device 100 is configured to include a control portion 110, a storage portion 140, a communication portion 150, and an input/output portion 160. The control portion 110 implements a function of the conversation support device 100 and controls the function by performing various types of calculation processes. The control portion 110 may be implemented by a dedicated member, but may include a processor and storage media such as a read only memory (ROM) and a random access memory (RAM). The processor reads a prescribed program pre-stored in the ROM, loads the read program into the RAM, and uses a storage area of the RAM as a work area. The processor implements functions of the control portion 110 by executing processes indicated in various types of commands described in the read program. The functions to be implemented may include a function of each part to be described below. In the following description, executing the process indicated in the instruction described in the program may be referred to as “executing the program,” “execution of the program,” or the like. The processor is, for example, a central processing unit (CPU) or the like.

The control portion 110 is configured to include a speech analysis portion 112, a speech recognition portion 114, a text acquisition portion 118, a text processing portion 120, a minutes creation portion 122, a topic analysis portion 124, a search portion 126, a display processing portion 134, a display control information acquisition portion 136, and a mode control portion 138.

Speech data is input from the sound collection portion 170 to the speech analysis portion 112 via the input/output portion 160. The speech analysis portion 112 calculates a speech feature quantity for each frame of a prescribed length with respect to the input speech data. The speech feature quantity is represented by a characteristic parameter indicating an acoustic feature of the speech in the frame. Speech feature quantities, which are calculated, include, for example, a power, the number of zero-crossings, mel-frequency cepstrum coefficients (MFCCs), and the like. Among the above speech feature quantities, the power and the number of zero-crossings are used to determine an utterance state. The MFCCs are used for speech recognition. The period of one frame is, for example, 10 ms to 50 ms.

The speech analysis portion 112 determines the utterance state for each frame on the basis of the calculated speech feature quantity. The speech analysis portion 112 performs a known speech section detection process (voice activity detection (VAD) and determines whether or not a processing target frame at that point in time (hereinafter, a “current frame”) is a speech section. The speech analysis portion 112 determines, for example, a frame in which the power is greater than a lower limit of prescribed power and the number of zero-crossings is within a prescribed range (for example, 300 to 1000 times per second) as an utterance section, and determines the other frames as non-speech sections. The speech analysis portion 112 determines that a frame (hereinafter, a “previous frame”) immediately before the current frame is a non-speech section, but determines the utterance state of the current frame as the start of utterance when the current frame is newly determined to be a speech section. A frame in which the utterance state is determined to be the start of utterance is referred to as an “utterance start frame.” The speech analysis portion 112 determines that the previous frame is a speech section, but determines the utterance state of the previous frame as the end of utterance when the current frame is newly determined to be a non-speech section. A frame whose utterance state is determined to be the end of utterance is referred to as an “utterance end frame.” The speech analysis portion 112 determines a series of sections from the utterance start frame to the next utterance end frame as one utterance section. One utterance section roughly corresponds to one utterance. The speech analysis portion 112 sequentially outputs speech feature quantities calculated for each determined utterance section to the speech recognition portion 114. When sound collection identification information is added to the input speech data, the sound collection identification information may be added to the speech feature quantity and output to the speech recognition portion 114. The sound collection identification information is identification information (for example, a microphone identifier (Mic ID) for identifying an individual sound collection portion 170.

The speech recognition portion 114 performs a speech recognition process on the speech feature quantity input from the speech analysis portion 112 for each utterance section using a speech recognition model pre-stored in the storage portion 140. The speech recognition model includes an acoustic model and a language model. The acoustic model is used to determine a phoneme sequence including one or more phonemes from the speech feature quantity. The acoustic model is, for example, a hidden Markov model (HMM). The language model is used to use a word or a phrase including the phoneme sequence. The language model is, for example, n-gram. The speech recognition portion 114 determines a word or a phrase having a highest likelihood calculated using the speech recognition model for the input speech feature quantity as a recognition result. The speech recognition portion 114 outputs first text information indicating text representing a word or a phrase constituting the utterance content as the recognition result to the text processing portion 120. That is, the first text information is information indicating the utterance text (hereinafter, “first text”) representing the utterance content of the collected speech.

When the sound collection identification information is added to the input speech feature quantity, the sound collection identification information may be added to the first text information and output to the text processing portion 120. The speech recognition portion 114 may identify a speaker by performing a known speaker recognition process on the input speech feature quantity. The speech recognition portion 114 may add speaker identification information (a speaker ID) indicating the identified speaker to the speech feature quantity and output the speech feature quantity to which the speaker identification information is added to the text processing portion 120. The speaker ID is identification information for identifying each speaker.

The text acquisition portion 118 receives text information from the terminal device 200 using the communication portion 150. The text acquisition portion 118 outputs the text information, which has been acquired, as the second text information to the text processing portion 120. The second text information is input in response to an operation on the operation portion 280 of the terminal device 200 and indicates text representing utterance content of an input person, mainly for the purpose of communicating with the participants in the conversation. The text acquisition portion 118 may receive text information on the basis of an operation signal input from the operation portion 180 via the input/output portion 160 using a method similar to that of the control portion 210 of the terminal device 200 to be described below. In the present application, the operation signal received from the terminal device 200 and the operation signal input from the operation portion 180 may be collectively referred to as “acquired operation signals” or simply as “operation signals.” The text acquisition portion 118 may add device identification information for identifying a device of either the operation portion 180 or the terminal device 200, which is an acquisition source of the operation signal, to the second text information and output the second text information to which the device identification information is added to the text processing portion 120. “Sound collection identification information,” “speaker identification information,” and “device identification information” may be collectively referred to as “acquisition source identification information.”

The text processing portion 120 acquires each of the first text indicated by the first text information input from the speech recognition portion 114 and the second text indicated by the second text information input from the text acquisition portion 118 as utterance text to be displayed by the display portion 190. The text processing portion 120 performs a prescribed process for displaying or saving the acquired utterance text as display text. For example, the text processing portion 120 performs known morphological analysis on the first text, divides the first text into one or a plurality of words, and identifies a part of speech for each word. The text processing portion 120 may delete text representing a word that does not substantially contribute to the utterance content, such as a word whose identified part of speech is an interjection or a word that is repeatedly spoken within a prescribed period (for example, 10 to 60 seconds), from the first text.

The text processing portion 120 may generate utterance identification information for identifying individual utterances with respect to the first text information input from the speech recognition portion 114 and the second text information input from the text acquisition portion 118 and add the generated utterance identification information to display text information indicating the display text related to the utterance. For example, the text processing portion 120 may generate the order in which the first text information or the second text information is input to the text processing portion 120 as the utterance identification information after the start of a series of conversations. The text processing portion 120 outputs the display text information to the minutes creation portion 122, the topic analysis portion 124, and the display processing portion 134. When acquisition source identification information is added to the first text information input from the speech recognition portion 114 or the second text information input from the text acquisition portion 118, the text processing portion 120 may add the acquisition source identification information to the display text information and output the display text information to which the acquisition source identification information is added to the minutes creation portion 122, the topic analysis portion 124, and the display processing portion 134.

The minutes creation portion 122 sequentially stores the display text information input from the text processing portion 120 in the storage portion 140. In the storage portion 140, the information is formed as minutes information including the stored individual display text information. As described above, the individual display text information indicates the utterance text conveyed in the first text information or the second text information. Accordingly, the minutes information corresponds to an utterance history (an utterance log) in which the utterance text is sequentially accumulated.

The minutes creation portion 122 may store date and time information indicating a date and time when the display text information is input from the text processing portion 120 in the storage portion 140 in association with the display text information. When the acquisition source identification information is added to the display text information, the minutes creation portion 122 may store the acquisition source identification information and the display text information in association with each other in the storage portion 140 in place of the date and time information or together with the date and time information. When the utterance identification information is added to the display text information, the minutes creation portion 122 may store the utterance identification information and the display text information in association with each other in the storage portion 140 in place of the date and time information or the acquisition source identification information, or together with the date and time information or the acquisition source identification information.

The topic analysis portion 124 extracts a word or a phrase (a keyword) related to a prescribed topic from the utterance text indicated in the display text information input from the text processing portion 120. Thereby, the topic of the utterance content conveyed in the utterance text or the keyword representing the topic is analyzed. The word or the phrase means a word or a phrase including a plurality of words and mainly forms an independent word such as a verb, a noun, an adjective, or an adverb. Therefore, the topic analysis portion 124 may perform morphological analysis on the utterance text, determine a word or a phrase, which forms a sentence represented by the utterance text, and a part of speech for each word, and determine an independent word as a processing target section.

The topic analysis portion 124 identifies either a word or a phrase described in a topic model from the utterance text with reference to, for example, the topic model pre-stored in the storage portion 140. The topic model is configured to include information indicating one or more words or phrases related to a topic for each prescribed topic. Some of the above words or phrases may be the same as a topic title (a topic name) Synonym data may be pre-stored in the storage portion 140. The synonym data is data (a synonym dictionary) in which other words or phrases having meanings similar to that of a word or a phrase serving as a headword are associated as synonyms for each word or phrase serving as the headword. The topic analysis portion 124 may identify a synonym corresponding to a word or a phrase that forms a part of the utterance text with reference to the synonym data and identify a word or a phrase that matches the identified synonym from words or phrases described in the topic model. The topic analysis portion 124 generates search instruction information for issuing an instruction for searching for text related to the extracted word or phrase or a topic related to the word or the phrase. The topic analysis portion 124 outputs the display text information serving as a processing target and the generated search instruction information to the search portion 126.

The search portion 126 searches for utterance text related to the search instruction information input from the topic analysis portion 124 as reference text in the utterance history (minutes information) stored in the storage portion 140. The search portion 126 identifies, for example, utterance text including a word or a phrase indicated in the search instruction information, words or phrases matching all synonyms corresponding to the above word or phrase, or words or phrases matching a number of words or phrases of a prescribed proportion or more as reference text from the utterance history. The search portion 126 can identify a synonym corresponding to the word or the phrase indicated in the search instruction information with reference to the above-described synonym data. Morphological analysis may be performed on a sentence indicated in each utterance text and part-of-speech information indicating a part of speech for each word or phrase constituting the sentence may be added to the utterance history. The search portion 126 may limit a word or a phrase included in the utterance text serving as a search target to an independent word with reference to part-of-speech information for each word or phrase and ignore words or phrases of the other parts of speech. The search portion 126 outputs the word or the phrase to the display processing portion 134 in association with the reference text information indicating the reference text obtained in the search. The search portion 126 may further output the search instruction information input from the topic analysis portion 124 to the display processing portion 134 in association with the display text information. The search portion 126 may output the search instruction information including information about a synonym included in the reference text found in the search.

The search portion 126 may have a plurality of pieces of utterance text found in the search as the reference text. In this case, the search portion 126 may preferentially select a predetermined prescribed number of (for example, one or more) pieces of utterance text or less having a shorter period from a date and time indicated in date and time information added to each piece of utterance text to that point in time (present) and discard the other utterance text. The search portion 126 may preferentially select utterance text having a larger number of words or phrases that matches words or phrases indicated in the search instruction information or synonyms corresponding to the words or the phrases indicated in the search instruction information.

The display processing portion 134 performs a process for displaying the display text indicated in the display text information input from the text processing portion 120. When no reference text information has been input from the search portion 126, i.e., when no reference text corresponding to the utterance text has been found in the search, the display processing portion 134 causes the display portion 190 or 290 to display the display text as it is. Here, the display processing portion 134 reads a display screen template pre-stored in the storage portion 140 and the display processing portion 134 updates a display screen by assigning newly input display text to a preset prescribed text display area for displaying display text within the display screen template. When there is no more area for assigning new display text to the text display area, the display processing portion 134 updates the display screen by scrolling through the display text in the text display area in a prescribed direction (for example, a vertical direction) every time the display text information is newly input from the text processing portion 120. In scrolling, the display processing portion 134 moves a display area of the already displayed display text already assigned to the text display area in a prescribed direction, and secures an empty area to which no display text is assigned. The empty area is provided in contact with one end of the text display area in a direction opposite to a movement direction of the display text within the text display area. The display processing portion 134 determines an amount of movement of the already displayed display text so that a size of the empty area, which is secured, is equal to a size of the display area required for displaying new display text. The display processing portion 134 assigns new display text to the secured empty area and deletes the already displayed display text arranged outside of the text display area according to movement.

On the other hand, when the reference text corresponding to the utterance text has been found in the search, the display processing portion 134 determines related information about the reference text information and updates a display screen so that the determined related information is displayed by the display portion 190 or 290 in association with the utterance text serving as the display text. In this case, one or both of the reference text information and the search instruction information are input from the search portion 126 to the display processing portion 134 in association with the display text information. The display processing portion 134 generates, for example, a display screen in which the reference text itself is included as an example of related information within a display frame that is the same as that of the display text. The display processing portion 134 may cause a word or a phrase indicated in the search instruction information (also including a synonym) within the display text to be included in the display screen in a display form different from those of the other parts, in place of the reference text, or together with the reference text. The above different display form is also an example of related information indicating a relationship with the reference text. As the display form, for example, any one of a color, luminance, brightness, a font, a size, the presence/absence of character decoration, and a type of character decoration, or a combination of some or all of the above items is applied. When the date and time information is stored in association with the reference text in the utterance history, the display processing portion 134 may cause the display portion 190 to display the date and time information in association with the reference text. When acquisition source identification information is stored in association with the reference text in the utterance history, the display processing portion 134 may cause the display portion 190 to display an acquisition source mark based on the acquisition source identification information in association with the reference text. A display example of the display text will be described below.

The display processing portion 134 may attempt to extract a word or a phrase indicated in the search instruction information as first element information from the utterance text serving as the display text and extract a word or a phrase indicated in the search instruction information as the second element information from the reference text. As described above, the word or the phrase indicated in the search instruction information correspond to a word or a phrase of a prescribed topic used to search for the reference text and a synonym thereof. Not all of the first element information completely matches all of the second element information and a part or all of the first element information may be changed from a part or all of the second element information. Therefore, the display processing portion 134 may compare the first element information with the second element information, generate related information about the change from the second element information, and include the generated related information in the display frame of the display text. There are three types of forms such as an omission, a modification, and an addition as the change. The display processing portion 134 may detect an omission or a modification of a part or all of the second element information as a change from the second element information or may detect an addition of a word or a phrase that is a part of the first element information, but does not exist in the second element information. The display processing portion 134 may generate a display screen on which a word or a phrase serving as a modified or added part of the first element information is displayed using a display form different from those of the other parts. The display processing portion 134 may generate a display screen on which a word or a phrase serving as a part or all of the second element information that has been deleted is displayed using a display form different from those of the other parts. In this case, the related information about the change is included as an example of the related information indicating a relationship with the reference text in a display form different from those of the other parts. As an example of the related information about the change, the display processing portion 134 may include text serving as guidance information indicating the change more explicitly in the display screen in association with a word or a phrase related to the change. When a first word or phrase serving as a part of the first element information becomes a second word or phrase serving as a part of the second element information and a synonym for the first word or phrase, the display processing portion 134 may not determine the change as a change from the second word or phrase to the first word or phrase and may not determine the conveyance target as a conveyance target in the related information.

Although a case in which the first element information and the second element information, which are the element information related to a prescribed topic, each include only a word or a phrase including characters has been described as an example in the above-described example, the present invention is not limited thereto. The element information may be configured to include a word or a phrase related to a prescribed topic and a numerical value having a prescribed positional relationship with the word or the phrase. The display processing portion 134 may determine that a change to a part of the second element information or a second numerical value has occurred when the first word or phrase included in a part of the first element information is the same as the second word or phrase included in a part of the second element information or has a synonym relationship with the second word or phrase and a first numerical value included in a part of the first element information is different from the second numerical value included in a part of the second element information. For example, the display processing portion 134 performs known morphological analysis on processing target text and determines a part of speech for each word constituting the sentence represented by the text and dependency between words. For example, the display processing portion 134 adopts a numerical value, which follows a word or a phrase and is within a prescribed number of clauses (for example, two to five clauses) from the word or the phrase as a numerical value having a prescribed positional relationship. The display processing portion 134 may adopt a numerical value which is previous to a word or a phrase and is within a range of a prescribed number of clauses from the word or the phrase, wherein the numerical value is a numerical value previous to a word indicating a starting point (for example, “from . . . ”) or a word indicating an ending point (for example, “to . . . ”). The term “within the range” may be limited to within a range of a sentence including the word or the phrase or may include a sentence previous to the sentence or a sentence subsequent to the sentence.

The display processing portion 134 may adopt a numerical value previous to a prescribed related word related to the word or the phrase among numerical values within the range. As the related word, a unit of a quantity related to the word or the phrase or the topic may be used. For example, “%” which is a unit of a progress rate as a related word that forms a unit of a quantity related to “progress,” “number” which is a unit of a quantity, “month,” “day,” “hour,” or “minute” which is a unit of a period of a business item or a starting point or an ending point thereof as a related word that forms a unit of a quantity related to “schedule,” and the like are applicable. Related word information indicating the related word may be pre-stored in the storage portion 140 in association with an individual word or phrase serving as element information of the topic included in the topic model. The display processing portion 134 can identify a prescribed topic or a related word corresponding to a word, a phrase, or a synonym related to the topic with reference to the related word information.

When text deletion information is input from the display control information acquisition portion 136 while the display screen is displayed, the display processing portion 134 may identify a section of a part of the display text assigned to the text display area and delete the display text within the identified section. The text deletion information is control information that indicates the deletion of the display text and the section of the display text serving as a target thereof. A target section may be identified using utterance identification information included in the text deletion information. The display processing portion 134 updates the display screen by moving newer other display text to an area where display text is deleted within the text display area (text filling).

The display processing portion 134 outputs display screen data representing the updated display screen to the display portion 190 via the input/output portion 160 each time the display screen is updated. The display processing portion 134 may transmit the display screen data to the terminal device 200 using the communication portion 150. Consequently, the display processing portion 134 can cause the display portion 190 of its own device and the display portion 290 of the terminal device 200 to display the updated display screen. The display screen displayed on the display portion 190 of the own device may include an operation area. Various types of screen components for operating the own device and displaying an operating state are arranged in the operation area.

The display control information acquisition portion 136 receives display control information for controlling the display of the display screen from the terminal device 200. The display control information acquisition portion 136 may generate a display control signal on the basis of an operation signal input via the input/output portion 160 using a method (to be described below) similar to that of the control portion 210 of the terminal device 200. The display control information acquisition portion 136 outputs the acquired display control information to the display processing portion 134. The extracted display control signal may include the above-described text deletion information.

The mode control portion 138 controls an operation mode of the conversation support device 100 on the basis of the acquired operation signal. The mode control portion 138 enables the necessity or combination of functions capable of being provided by the conversation support device 100 to be set as the operation mode. The mode control portion 138 extracts mode setting information related to the mode setting from the acquired operation signal and outputs mode control information for issuing an instruction for the operation mode indicated in the extracted mode setting information to each part.

The mode control portion 138 can control, for example, the start of an operation, the end of the operation, the necessity of creation of minutes, the necessity of recording, and the like. When the extracted mode setting information indicates the start of the operation, the mode control portion 138 outputs the mode control information indicating the start of the operation to each part of the control portion 110. Each part of the control portion 110 starts a prescribed process in the own part when the mode control information indicating the start of the operation is input from the mode control portion 138. When the extracted mode setting information indicates the end of the operation, the mode control portion 138 outputs the mode control information indicating the end of the operation to each part of the control portion 110. Each part of the control portion 110 ends a prescribed process in the own part when the mode control information indicating the end of the operation is input from the mode control portion 138. When the extracted mode setting information indicates the creation of minutes, the mode control portion 138 outputs the mode control information indicating the creation of minutes to the minutes creation portion 122. When the extracted mode setting information indicates the creation of minutes, the mode control portion 138 outputs the mode control information indicating the creation of minutes to the minutes creation portion 122. When mode control information indicating the necessary creation of minutes is input from the mode control portion 138, the minutes creation portion 122 starts the storage of the display text information input from the text processing portion 120 in the storage portion 140. Consequently, the creation of minutes is started. When the extracted mode setting information indicates the unnecessary creation of minutes, the mode control portion 138 outputs the mode control information indicating the unnecessary creation of minutes to the minutes creation portion 122. When the mode control information indicating the unnecessary creation of minutes is input from the mode control portion 138, the minutes creation portion 122 stops the storage of the display text information input from the text processing portion 120 in the storage portion 140. Consequently, the creation of minutes is stopped.

The storage portion 140 stores various types of data for use in a process in the control portion 110 and various types of data acquired by the control portion 110. The storage portion 140 is configured to include, for example, the above-mentioned storage media such as a ROM and a RAM.

The communication portion 150 connects to a network wirelessly or by wire using a prescribed communication scheme and enables transmission and reception of various types of data to and from other devices. The communication portion 150 is configured to include, for example, a communication interface. The prescribed communication scheme may be a scheme defined by any standard among IEEE 802.11, the 4^{th} generation mobile communication system (4G), the 5^{th} generation mobile communication system (5G), and the like.

The input/output portion 160 can input and output various types of data wirelessly or by wire from and to other members or devices using a prescribed input/output scheme. The prescribed input/output scheme may be, for example, a scheme defined by any standard among a universal serial bus (USB), IEEE 1394, and the like. The input/output portion 160 is configured to include, for example, an input/output interface.

The sound collection portion 170 collects speech arriving at the own portion and outputs speech data indicating the collected speech to the control portion 110 via the input/output portion 160. The sound collection portion 170 includes a microphone. The number of sound collection portions 170 is not limited to one and may be two or more. The sound collection portion 170 may be, for example, a portable wireless microphone. The wireless microphone mainly collects speech uttered by an individual owner.

The operation portion 180 receives an operation by the user and outputs an operation signal based on the received operation to the control portion 110 via the input/output portion 160. The operation portion 180 may include a general-purpose input device such as a touch sensor, a mouse, or a keyboard or may include a dedicated member such as a button, a knob, or a dial.

The display portion 190 displays display information based on display data such as display screen data input from the control portion 110, for example, various types of display screens. The display portion 190 may be, for example, any type of display among a liquid crystal display (LCD), an organic electro-luminescence display (OLED), and the like. A display area of a display forming the display portion 190 may be configured as a single touch panel in which detection areas of touch sensors forming the operation portion 180 are superimposed and integrated.

### (Terminal Device)

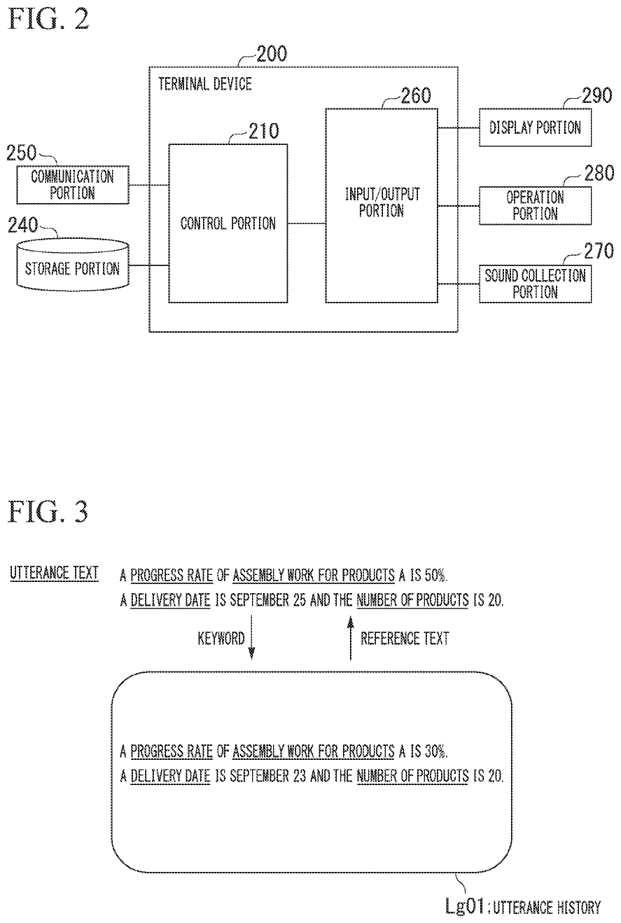

Next, an example of a configuration of the terminal device 200 according to the present embodiment will be described. FIG. 2 is a block diagram showing an example of a functional configuration of the terminal device 200 according to the present embodiment.

The terminal device 200 is configured to include a control portion 210, a storage portion 240, a communication portion 250, an input/output portion 260, a sound collection portion 270, an operation portion 280, and a display portion 290.

The control portion 210 implements a function of the terminal device 200 and controls the function by performing various types of calculation processes. The control portion 210 may be implemented by a dedicated member, but may include a processor and a storage medium such as a ROM or a RAM. The processor reads a prescribed control program pre-stored in the ROM, loads the read program into the RAM, and uses a storage area of the RAM as a work area. The processor implements functions of the control portion 210 by executing processes indicated in various types of commands described in the read program.

The control portion 210 receives display screen data from the conversation support device 100 using the communication portion 250 and outputs the received display screen data to the display portion 290. The display portion 290 displays a display screen based on the display screen data input from the control portion 210. The control portion 210 receives an operation signal indicating a character from the operation portion 280 while the display screen is displayed and uses the communication portion 250 for the conversation support device 100 to transmit text information indicating text including one or more characters that have been received (a text input). The text received at this stage corresponds to the above-described second text.

The control portion 210 identifies a partial section indicated in an operation signal input from the operation portion 280 within display text assigned in a text display area of the display screen and generates text deletion information indicating the deletion of the display text using the identified section as a target when a deletion instruction is issued by an operation signal (text deletion). The control portion 210 transmits the text deletion information generated using the communication portion 250 to the conversation support device 100.

The storage portion 240 stores various types of data for use in a process of the control portion 210 and various types of data acquired by the control portion 210. The storage portion 240 is configured to include storage media such as a ROM and a RAM.

The communication portion 250 connects to a network wirelessly or by wire using a prescribed communication scheme, and enables transmission and reception of various types of data to and from other devices. The communication portion 250 is configured to include, for example, a communication interface.

The input/output portion 260 can input and output various types of data from and to other members or devices using a prescribed input/output scheme. The input/output portion 260 is configured to include, for example, an input/output interface.

The sound collection portion 270 collects speech arriving at the own portion and outputs speech data indicating the collected speech to the control portion 210 via the input/output portion 260. The sound collection portion 270 includes a microphone. The speech data acquired by the sound collection portion 270 may be transmitted to the conversation support device 100 via the communication portion 250 and a speech recognition process may be performed in the conversation support device.

The operation portion 280 receives an operation by the user and outputs an operation signal based on the received operation to the control portion 210 via the input/output portion 260. The operation portion 280 includes an input device.

The display portion 290 displays display information based on display data such as display screen data input from the control portion 210. The display portion 290 includes a display. The display forming the display portion 290 may be integrated with a touch sensor forming the operation portion 280 and configured as a single touch panel.

### (Operation Examples)

Next, an example of an operation of the conversation support system S1 according to the present embodiment will be described. FIG. 3 is an explanatory diagram showing a first search example of the reference text. In the example shown in FIG. 3, it is assumed that the latest utterance text “A progress rate of assembly work for products A is 50%. The delivery date is September 25 and the number of products is 20.” acquired at that point in time is a processing target. In this case, the topic analysis portion 124 of the conversation support device 100 identifies a word or a phrase “products,” “assembly work,” “progress rate,” “delivery date,” or “number of products” related to a topic “work progress” from the utterance text. In FIG. 3, a word or a phrase used as a keyword in the utterance text is underlined.

The search portion 126 searches for reference text having words or phrases that matches all or some of keywords from an utterance history Lg01 using a word or a phrase extracted from the utterance text as the keyword. Here, the search portion 126 searches for the previous utterance text “A progress rate of assembly work for products A is 30%. The delivery date is September 23 and the number of products is 20.” including all keywords as reference text.

The display processing portion 134 can identify element information of “progress rate is 50%” in which the keywords “progress rate” identified from the display text and a numerical value of “50%” placed behind “progress rate” are combined, element information of “delivery date is September 25” in which “delivery date” and a numerical value of “September 25” placed behind “delivery date” are combined, and element information of “number of products is 20” in which “number of products” and “20” placed behind “number of products” are combined. On the other hand, the display processing portion 134 can identify element information of “progress rate is 30%” in which “progress rate” identified from the reference text and a numerical value of “30%” placed behind “progress rate” are combined, element information of “delivery date is September 23” in which “delivery date” and a numerical value of “September 23” placed behind “delivery date” are combined, and element information of “number of products is 20” in which “number of products” and “20” placed behind “number of products” are combined.

The display processing portion 134 can determine that there is a change from “progress rate is 30%” of the reference text to “progress rate is 50%” of the utterance text with respect to the same keywords “progress rate” and that there is a change from “delivery date is September 23” of the reference text to “delivery date is September 25” of the utterance text with respect to the same keywords “delivery date.” However, the display processing portion 134 can determine that the element information of the utterance text of “number of products is 20” does not change from that of the reference text with respect to the same keywords “number of products.”

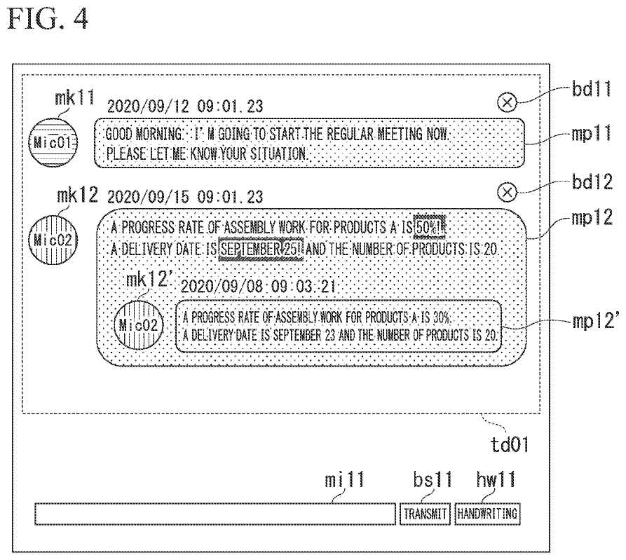

FIG. 4 is a diagram showing a first display example of the display screen. This display screen may be displayed on one or both of the display portion 190 of the conversation support device 100 and the display portion 290 of the terminal device 200. Hereinafter, an operation on the terminal device 200 and display content of the terminal device 200 will be described using a case in which content is displayed on the display portion 290 as an example. On the display screen shown in the example of FIG. 4, the display text for each utterance is displayed within a display frame (a speech balloon). For display text in which there is reference text, the reference text is displayed within the display frame surrounding the display text. In a display frame mp12, the utterance text shown in the example of FIG. 3 is arranged as the display text and the reference text is further arranged. The reference text itself is displayed as related information.

A text display area td01, a text input field mi11, a transmit button bs11, and a handwriting button hw11 are arranged on the display screen. The text display area td01 occupies most of the area of the display screen (for example, half of an area ratio or more). In the text display area td01, a set of an acquisition source identification mark and a display frame is arranged for an individual utterance. When the display screen is updated, the display processing portion 134 of the conversation support device 100 arranges a display frame in which the acquisition source identification mark corresponding to the acquisition source identification information added to the display text information and the display text indicated in the display text information are arranged on each line within the text display area every time the display text information is acquired. The display processing portion 134 arranges date and time information at the upper left end of an individual display frame and a delete button at the upper right end. When new display text information is acquired after the text display area td01 is filled with the set of the acquisition source identification mark and the display frame, the display processing portion 134 moves the set of the acquisition source identification mark and the display frame that have already been arranged in a prescribed direction (for example, an upward direction) and disposes a set of a display frame in which the new display text is arranged and an acquisition source identification mark related to the display text in an empty area generated at an end (for example, downward) in the movement direction of the text display area td01 (scroll). The display processing portion 134 deletes the set of the acquisition source identification mark and the display frame that move outside of the text display area td01.

The acquisition source identification mark is a mark indicating the acquisition source of an individual utterance. In the example shown in FIG. 4, sound collection portion marks mk11 and mk12 correspond to acquisition source identification marks indicating microphones Mic01 and Mic02 as the acquisition sources, respectively. The display processing portion 134 extracts the acquisition source identification information from each piece of the first text information and the second text information input to the own portion and identifies the acquisition source indicated in the extracted acquisition source identification information. The display processing portion 134 generates an acquisition source identification mark including text indicating the identified acquisition source. The display processing portion 134 may cause a symbol or a figure for identifying an individual acquisition source to be included in the acquisition source identification mark together with or in place of the text. The display processing portion 134 may set a form which differs in accordance with the acquisition source for the acquisition source identification mark and display the acquisition source identification mark in the set form. A form of the acquisition source identification mark may be, for example, any one of a background color, a density, a display pattern (highlight, shading, or the like), a shape, and the like.

Display frames mp11 and mp12 are frames in which display text indicating individual utterances is arranged. Date and time information and a delete button are arranged at the upper left end and the upper right end of an individual display frame, respectively. The date and time information indicates a date and time when the display text arranged within the display frame has been acquired. The delete buttons bd11 and bd12 are buttons for issuing an instruction for deleting the display frames mp11 and mp12 and the acquisition source identification information, which are arranged in association with each other, by pressing the delete buttons bd11 and bd12. In the present application, the term “pressing” means that a screen component such as a button is indicated, that a position within the display area of the screen component is indicated, or that an operation signal indicating the position is acquired. For example, when the pressing of the delete button bd11 is detected, the display processing portion 134 deletes the sound collection portion mark mk11 and the display frame mp11 and deletes the date and time information “2020/09/12 09:01.23” and the delete button bd11. The control portion 210 of the terminal device 200 identifies a delete button that includes the position indicated in the operation signal received from the operation portion 280 within the display area, generates text deletion information indicating the deletion of a display frame including display text and an acquisition source mark corresponding to the delete button, and transmits the text deletion information to the display control information acquisition portion 136 of the conversation support device 100. The display control information acquisition portion 136 outputs the text deletion information received from the terminal device 200 to the display processing portion 134. The display processing portion 134 updates the display screen by deleting the display frame and the acquisition source mark indicated in the text deletion information from the display control information acquisition portion 136 and deleting the date and time information and the delete button attached to the display frame.

The display frame mp12 includes the display text and the reference text that are arranged in that order. Thereby, it is clearly shown that the reference text is related to the display text. The display text and the reference text correspond to the display text and reference text shown in the example of FIG. 3, respectively. A highlighted part of the display text indicates element information that has been changed from the element information of the reference text. Furthermore, an exclamation mark “!” is added to the highlighted part at a position that does not overlap the text. The highlighted part and the exclamation mark “!” are also configured as examples of related information indicating a relationship with the reference text. The user who visually recognizes the display screen notices that the element information of “progress rate is 50%” and “delivery date is September 25” in the display text has changed from information of “progress rate is 30%” and “delivery date is September 23” as corresponding element information in the reference text.

On the other hand, the reference text is displayed within the area of the display frame mp12′ and is further associated with the sound collection portion mark mk12′ and the date and time information. Here, it is displayed that the acquisition source of the reference text is the microphone Mic02 and the acquisition date and time is “2020/09/08 09:03.21.” By arranging all of the above display elements in the display frame mp12, it is shown that they have a relationship subordinate to the display text.

The display processing portion 134 may also cause a delete button bd12′ (not shown) to be included in and displayed on the display screen in the vicinity of the display frame mp12′ (for example, within an area of a prescribed range from the upper right end of the display frame mp12′). When it is detected that the delete button bd12′ is pressed, the display processing portion 134 may delete the sound collection portion mark mk12′, the acquisition date and time, the display frame mp12′, the reference text, and the delete button bd12′.

A text input field mi11 is a field for receiving an input of text. The control portion 210 of the terminal device 200 identifies characters indicated in the operation signal input from the operation portion 280 and sequentially arranges the identified characters in the text input field mi11. The number of characters capable of being received at one time is limited within a range of a size of the text input field mi11. The number of characters may be predetermined on the basis of a range such as the typical number of characters and the number of words that forms one utterance (for example, within 30 to 100 full-width Japanese characters).

A transmit button bs11 is a button for issuing an instruction for transmitting text including characters arranged in the text input field mi11 when pressed. When the transmit button bs11 is indicated in the operation signal input from the operation portion 280, the control portion 210 of the terminal device 200 transmits text information indicating the text arranged in the text input field mi11 to the text acquisition portion 118 of the conversation support device 100 at that point in time.

A handwriting button hw11 is a button for issuing an instruction for a handwriting input by pressing. When the handwriting button hw11 is indicated in the operation signal input from the operation portion 280, the control portion 210 of the terminal device 200 reads handwriting input screen data pre-stored in the storage portion 240 and outputs the handwriting input screen data to the display portion 290. The display portion 290 displays a handwriting input screen (not shown) on the basis of the handwriting input screen data input from the control portion 210. The control portion 210 sequentially identifies positions within the handwriting input screen by an operation signal input from the operation portion 280, and transmits handwriting input information indicating a curve including a trajectory of the identified positions to the conversation support device 100. When the handwriting input information is received from the terminal device 200, the display processing portion 134 of the conversation support device 100 sets the handwriting display area at a prescribed position within the display screen. The handwriting display area may be within the range of the text display area or may be outside of the range. The display processing portion 134 updates the display screen by arranging the curve indicated in the handwriting input information within the set handwriting display area.

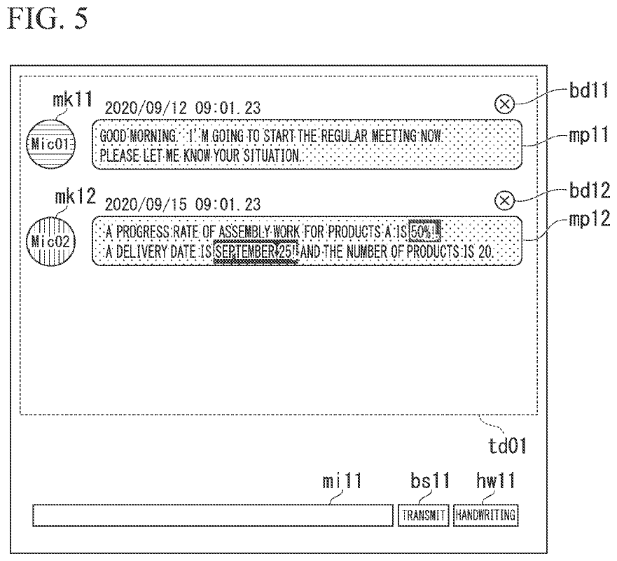

FIG. 5 is a diagram showing a second display example of the display screen. In the display frame mp12 of the display screen shown in the example of FIG. 5, unlike the example shown in FIG. 4, the display of the reference text and the acquisition source and the date and time information related to the reference text is omitted. However, the highlighted part and the exclamation mark “!,” which are related information, are displayed in the parts of “50%” and “September 25” changed from the reference text that forms the element information of the display text. The user who has access to the related information can intuitively ascertain that there are display text and reference text having the same topic as utterance content and a change has occurred in a part or all of element information thereof. Therefore, when an operation signal indicating that any element information is pressed is input, the display processing portion 134 may cause the reference text to be included in and displayed on the display frame mp12. In this case, a screen similar to the display screen shown in FIG. 4 is displayed. The display processing portion 134 may cause the element information of the reference text corresponding to the pressed element information to be displayed within the display frame mp12. Thereby, the reference text or element information of a change source, which forms a part thereof, can be arbitrarily displayed in association with the display text or the element information thereof in accordance with the user's need.

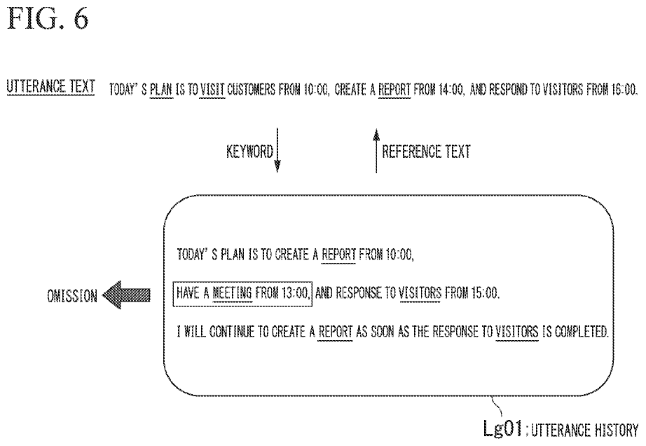

FIG. 6 is an explanatory diagram showing a second search example of the reference text. In the example shown in FIG. 6, it is assumed that the latest utterance text “Today's plan is to visit customers from 10:00, create a report from 14:00, and respond to visitors from 16:00” acquired at that point in time is a processing target. In this case, the topic analysis portion 124 of the conversation support device 100 identifies the words “plan,” “visit,” “report,” and “visitors” related to the topic “schedule” from the utterance text as keywords. The search portion 126 searches for reference text having words or phrases that match all or some of keywords extracted from the utterance text from the utterance history Lg01. Here, the search portion 126 searches for the previous utterance text “Today's plan is to create a report from 10:00, have a meeting from 13:00, and response to visitors from 15:00. I will continue to create the report as soon as the response to the visitors is completed.” including “schedule,” “report,” and “visitors” among these keywords as the reference text.

The words “plan,” “report,” “meeting,” and “visitors” included in the reference text are all words related to the topic “schedule” of the utterance content of the utterance text. Among the above words, “meeting” is a word that is not included in the utterance text. Although not included in the above utterance text, the display processing portion 134 can identify a word or a phrase related to the same topic as a word or a phrase used for searching for the reference text with reference to the topic model. The display processing portion 134 can determine that the element information related to “meeting” as a word related to the topic related to the word used for searching for the reference text, which is not included in the utterance text, is omitted from the utterance text. Here, the display processing portion 134 can determine that the information element “meeting from 13:00” in which “meeting” or “13:00” placed behind “meeting” are combined is element information forming reference text, but is element information not included in the utterance text.

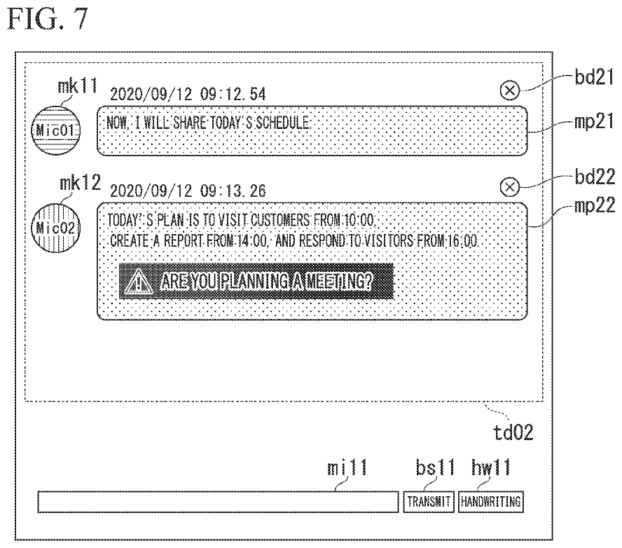

FIG. 7 is a diagram showing a third display example of the display screen. Also, in a display frame mp22 of the display screen shown in the example of FIG. 7, the display of the reference text and the acquisition source mark and the date and time information related to the reference text is omitted. However, the display frame mp22 includes guide display instead of the reference text. This guide display is also an example of related information indicating a relationship with the reference text. The guide display includes a caution symbol and a guidance message that are arranged in that order. The caution symbol includes a triangle and an exclamation mark “!” inside the triangle. The guidance message includes the text “Are you planning a meeting?” representing an omission guidance message for giving guidance on the information element “meeting” omitted from the reference text shown in the example of FIG. 6. Accordingly, the user who has access to the guide display can easily notice that the information element related to “meeting” is omitted from utterance content conveyed in the utterance text shown in the example of FIG. 6. Thus, the user is prompted to input an utterance or text including an information element related to “meeting.”

When the omission guidance message is generated, the display processing portion 134 reads, for example, an omission guide display sentence pattern “Are you planning . . . ?” pre-stored in the storage portion 140 and inputs a word “meeting” serving as an information element omitted from the omission guide display sentence pattern. The omission guide display sentence pattern is data indicating an input field for inputting a word or a phrase forming an omitted information element and text indicating a typical sentence pattern forming the omission guidance message for giving guidance on the omitted information element.

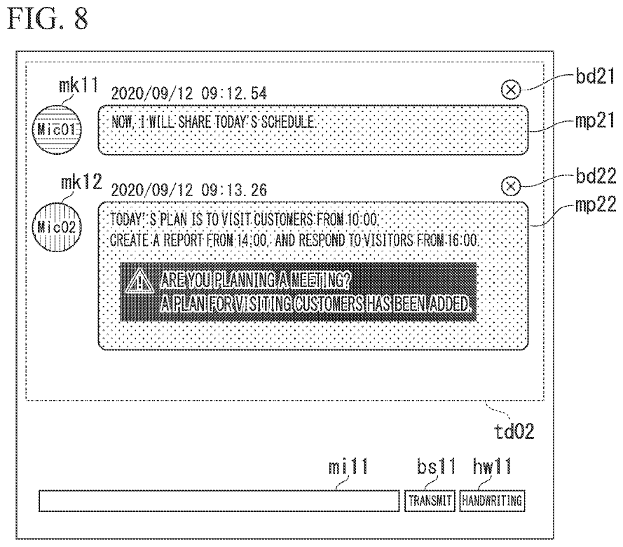

FIG. 8 is a diagram showing a fourth display example of the display screen. A display frame mp22 of the display screen shown in FIG. 8 further includes addition guidance text “A plan for visiting customers has been added.” indicating a message for giving guidance on an information element “visiting customers” added in the utterance text with respect to the reference text shown in the example of FIG. 6. The guide display including the above addition guidance text is also an example of related information indicating a relationship with the reference text. Accordingly, the user who has access to the guide display can easily notice that the information element related to “visiting customers” is added to utterance content conveyed in the utterance text shown in the example of FIG. 6. When the addition guidance message is generated, the display processing portion 134 reads, for example, an addition guide display sentence pattern “A plan for . . . has been added.” pre-stored in the storage portion 140 and inputs the phrase “visiting customers” serving as the information element added to the addition guide display sentence pattern. The addition guide display sentence pattern is data indicating an input field for inputting a word or a phrase forming the added information element and text indicating a typical sentence pattern forming an addition guidance message for giving guidance on the addition of the information element.

The omission guide display sentence pattern and the addition guide display sentence pattern each include text indicating a different message for each topic, and may be pre-stored in the storage portion 140 in association with a topic related to an omitted or added word, phrase, or component. The display processing portion 134 can identify the guide display sentence pattern to be used for generating the guidance message by identifying a topic related to an omitted or added word or phrase or a component with reference to the topic model pre-stored in the storage portion 140 as described above. As shown in the example of FIG. 6 or 7, if the guide display is included in and displayed on the display screen, the display processing portion 134 may cause the reference text to be displayed in association with the display text by deleting the guide display when pressing on the guide display is detected (see FIG. 4).

In the above-described display example, the display and non-display of the reference text can be switched in accordance with an operation. Therefore, the display processing portion 134 may count a display request frequency, which is a frequency at which a display instruction is issued for each word or phrase of a prescribed topic included in the reference text and store the counted display request frequency in the storage portion 140. The display processing portion 134 may cause reference text including a word or a phrase whose display request frequency stored in the storage portion 140 exceeds a prescribed display determination threshold value to be displayed in association with the display text and may not cause reference text including a word or a phrase whose display request frequency stored in the storage portion 140 is less than or equal to the prescribed display determination threshold value to be displayed. The display processing portion 134 may count a deletion request frequency, which is a frequency at which a deletion instruction is issued for each word or phrase of a prescribed topic included in the reference text and store the counted deletion request frequency in the storage portion 140. The display processing portion 134 may not cause reference text including a word or a phrase whose deletion request frequency stored in the storage portion 140 exceeds a prescribed deletion determination threshold value to be displayed in association with the display text and may cause reference text including a word or a phrase whose deletion request frequency stored in the storage portion 140 is less than or equal to the prescribed deletion determination threshold value to be displayed.

In the reference text, the number of words or phrases serving as a count target of the display request frequency may be two or more. In this case, the display processing portion 134 may determine the propriety of display on the basis of a representative value of the display request frequency (a maximum value, an average value, or the like) determined with respect to each of the plurality of words or phrases. Likewise, the number of words or phrases serving as a count target of the deletion request frequency may be two or more. In this case, the display processing portion 134 may determine the propriety of display on the basis of a representative value of the deletion request frequency determined with respect to each of the plurality of words or phrases.

### (Topic Model)

Next, the topic model according to the present embodiment will be described. The topic model is data indicating a probability of appearance of each of a plurality of words or phrases representing an individual topic. In other words, a topic is characterized by a probability distribution (a word distribution) between a plurality of typical words or phrases. A method of expressing an individual topic with a probability distribution between a plurality of words or phrases is referred to as a bag of words (BoW) expression. In the BoW expression, the word order of a plurality of words constituting a sentence is ignored. This is based on the assumption that the topic does not change as the word order changes.

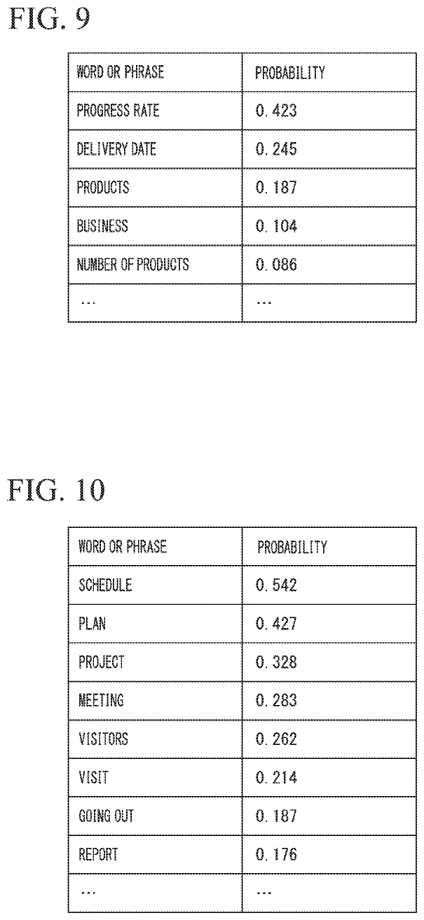

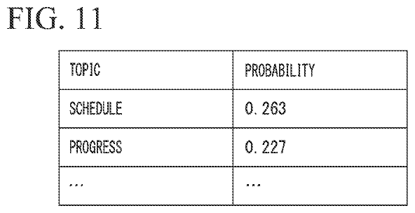

FIGS. 9 and 10 are diagrams showing an example of word distribution data of the topic model according to the present embodiment. FIG. 9 shows an example of a part whose topic is “business progress.” In the example shown in FIG. 9, words or phrases related to the topic “business progress” include “progress rate,” “delivery date,” “products,” “business,” and “number of products.” In the example shown in FIG. 10, “schedule,” “plan,” “project,” “meeting,” “visitors,” “visit,” “going out,” and “report” are used as the word or the phrase related to the topic “business progress.” In FIGS. 9 and 10, the probability of appearance when the topic is included in the utterance content is shown in association with an individual word or phrase. In the present embodiment, as a word or a phrase related to an individual topic, an independent word related to a word or a phrase whose appearance probability is greater than a threshold value of the appearance probability of a prescribed word or phrase when the topic is conveyed is adopted. In the present embodiment, the appearance probability may be omitted without being necessarily included and stored in the topic model.

FIG. 11 is a diagram showing an example of topic distribution data of the topic model according to the present embodiment. The topic distribution data is data indicating an appearance probability of an individual topic appearing in the entire document of an analysis target. The topic model includes topic distribution data generally, but the topic distribution data may be omitted without being stored in the storage portion 140 in the present embodiment. In the example shown in FIG. 11, the appearance probability for each topic obtained by analyzing an utterance history forming minutes information is shown. In the topic distribution data shown in FIG. 11, “schedule” and “progress” are included as individual topics, and the topics are arranged in descending order of appearance probability. In the present embodiment, a topic whose appearance probability is greater than the threshold value of the appearance probability of a prescribed topic is adopted and other topics may not be used. Thereby, reference information related to the reference text for topics that are frequently on the agenda is provided and the provision of reference information for other topics is limited.

The conversation support device 100 may include a topic model update portion (not shown) for updating the topic model in the control portion 110. The topic model update portion performs a topic model update process (learning) using the utterance history stored in the storage portion 140 as training data (also called teacher data). Here, it is assumed that the utterance history has a plurality of documents and an individual document has one or more topics. In the present embodiment, each of the individual documents may be associated with one meeting. As described above, each utterance may include only one sentence or may include a plurality of sentences. A single utterance may have one topic or a plurality of utterances may have one common topic.

In a topic model update process, a topic distribution θₘ is defined for each document m. The topic distribution θₘ is a probability distribution having a probability θₘₗ that a document m will have a topic 1 as an element for each topic 1. However, a probability θₘₗ is a real number of 0 or more and 1 or less and a sum of probabilities θₘₗ of topics 1 is normalized to be 1. As described above, in the topic model, a word distribution ϕₗ is defined for each topic 1. A word distribution ϕₗ is a probability distribution having an appearance probability ϕₗₖ of a word k in the topic 1 as an element. The appearance probability ϕₗₖ is a real number of 0 or more and 1 or less and a sum of probabilities ϕₗₖ of words K is normalized to be 1.

The topic model update portion can use, for example, a latent Dirichlet allocation (LDA) method, in the topic model update process. The LDA method is based on the assumption that the word and topic distributions each follow a multinomial distribution and their prior distributions follow a Dirichlet distribution. The multinomial distribution shows a probability distribution of probabilities obtained by executing an operation of extracting one word or phrase from K kinds of words or phrases N times when the appearance probability of a word or a phrase k is ϕₖ. The Dirichlet distribution shows a probability distribution of parameters of the multinomial distribution under the constraint that the appearance probability ϕₖ of the word or the phrase k is 0 or more and a sum of probabilities of K types of words or phrases is 1. Therefore, the topic model update portion calculates a word or phrase distribution and its prior distribution for each topic with respect to the entire document of an analysis target and calculates a topic distribution indicating the appearance probability of an individual topic and its prior distribution.

Unknown variables of a topic model are a set of topics including a plurality of topics, a topic distribution including an appearance probability for each topic of the entire document, and a phrase distribution group including a phrase distribution for each topic. According to the LDA method, the above unknown variables can be determined on the basis of a parameter group (also referred to as a hyperparameter) that characterizes each of the multinomial distribution and the Dirichlet distribution described above. The topic model update portion can recursively calculate a set of parameters that maximizes a logarithmic marginal likelihood given in the above unknown variables, for example, using the variational Bayesian method. A marginal likelihood corresponds to a probability density function when the prior distribution and the entire document of an analysis target are given. Here, maximization is not limited to finding a maximum value of the logarithmic marginal likelihood, but means performing a process of calculating or searching for a parameter group that increases the logarithmic marginal likelihood. Thus, the logarithmic marginal likelihood may temporarily decrease in the maximization process. In the calculation of the parameter group, a constraint condition that a sum of appearance probabilities of words or phrases becomes 1 with respect to appearance probabilities forming the individual word or phrase distributions is imposed. The topic model update portion can determine a topic set, a topic distribution, and a word or phrase distribution group as a topic model using the calculated parameter group.

By updating the topic model using the utterance history, the topic model update portion reflects a topic that frequently appears as the utterance content in the utterance history or a word or a phrase that frequently appears when the topic is the utterance content in the topic model.

The topic model update portion may use a method such as a latent semantic indexing (LSI) method instead of the LDA method in the topic model update process.

Instead of providing the topic model update portion, the control portion 110 may transmit the utterance history of its own device to another device and request the generation or update of the topic model. The control portion 110 may store the topic model received from the request destination device in the storage portion 140 and use the stored topic model in the above-described process on the individual utterance text.

### (Display Process)

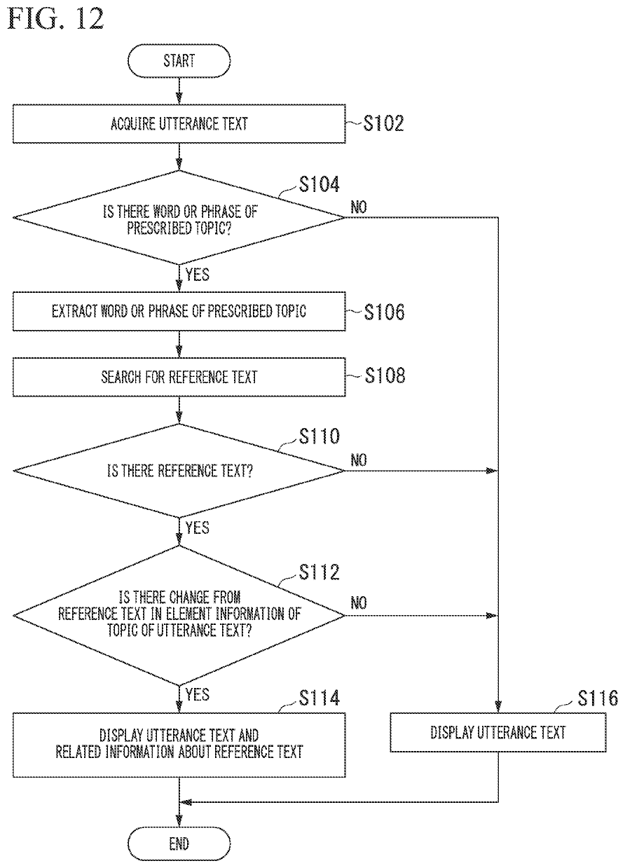

Next, an example of a process of displaying utterance text according to the present embodiment will be described. FIG. 12 is a flowchart showing an example of the process of displaying utterance text according to the present embodiment.

(Step S102) The text processing portion 120 acquires first text information input from the speech recognition portion 114 or second text information input from the text acquisition portion 118 as display text information indicating the utterance text (utterance text acquisition). Subsequently, the process proceeds to the processing of step S104.

(Step S104) The topic analysis portion 124 attempts to detect a word or a phrase related to a prescribed topic from the utterance text indicated in the acquired display text information with reference to topic data and determines whether or not there is a word or a phrase related to a prescribed topic in the utterance text. When it is determined that there is a word or a phrase of a prescribed topic (YES in step S104), the process proceeds to the processing of step S104. When it is determined there is no word or phrase of a prescribed topic (NO in step S104), the process proceeds to the processing of step S116.

(Step S106) The topic analysis portion 124 extracts a word or a phrase of a prescribed topic from the utterance text and generates search instruction information for issuing an instruction for searching for text using the extracted word or phrase, a synonym, or the topic. Subsequently, the process proceeds to step S108.

(Step S108) The search portion 126 searches for utterance text including a word or a phrase or a synonym indicated in the search instruction information, or utterance text having its topic as utterance content, as the reference text from an utterance history. Subsequently, the process proceeds to the processing of step S110.

(Step S110) The display processing portion 134 determines whether or not there is reference text found in the search. When it is determined that there is reference text (YES in step S110), the process proceeds to the processing of step S112. When it is determined that there is no reference text (NO in step S110), the process proceeds to the processing of step S116.

(Step S112) The display processing portion 134 determines whether or not a change from second element information including a word, a phrase, or a synonym indicated in the search instruction information included in the reference text or a word, a phrase, or a synonym related to its topic has occurred in a part or all of first element information including a word, a phrase, or a synonym indicated in the search instruction information included in the utterance text or a word, a phrase, or a synonym related to its topic. When it is determined that a change has occurred (YES in step S112), the process proceeds to the processing of step S114. When it is determined that no change has occurred (NO in step S112), the process proceeds to the processing of step S116.

(Step S114) The display processing portion 134 uses the utterance text as display text, includes the display text in the display screen in association with related information about the reference text, and causes the display text to be displayed on one or both of the display portion 190 and the display portion 290. Subsequently, the process shown in FIG. 12 ends.

(Step S116) The display processing portion 134 uses the utterance text as the display text, includes the display text in the display screen, and causes the display text to be displayed on one or both of the display portion 190 and the display portion 290. Subsequently, the process shown in FIG. 12 ends.

As described above, the conversation support device 100 according to the present embodiment includes the topic analysis portion 124 configured to extract a word or a phrase of a prescribed topic from utterance text representing utterance content. The conversation support device 100 includes the search portion 126 configured to search for reference text related to the prescribed topic in a storage portion in which an utterance history including previous utterance text is saved. The conversation support device 100 includes the display processing portion 134 configured to output the utterance text and related information about the reference text in association with each other to the display portion 190 or 290.

According to the above configuration, the previous reference text having the same topic as the utterance text is searched for and related information about the reference text found in the search is displayed in association with the utterance text. Because a user can have access to the related information about the reference text having the same topic as the utterance text in comparison with the utterance text, he or she can more easily understand the utterance content conveyed in the utterance text.

When the display processing portion 134 may extract the first element information related to a prescribed topic from the utterance text and the second element information related to the prescribed topic from the reference text and output related information about a change to the display portion 190 or 290 when a change from the second element information occurs in the first element.

According to the above configuration, the related information about the change from the second element information of the reference text in the first element information of the utterance text is displayed. Thus, the user can easily notice a difference of the utterance text from the reference text and can more easily understand the utterance content conveyed in the utterance text with the difference from the reference text.

The display processing portion 134 may determine an omission or a modification of at least a part of the second element information or a partial addition to the first element information as the change.

According to the above configuration, the related information about the change of an omission or modification of the second element information or addition to the first element information is displayed.

The display processing portion 134 may determine a change in a prescribed numerical value included in the second element information as the change.

According to the above configuration, the related information about the change in the prescribed numerical value included in the second element information corresponding to the first element information is displayed.

The display processing portion 134 may cause the display portion 190 or 290 to display a part in which the change has occurred in a form different from those of the other parts.

According to the above configuration, element information displayed in a part where the change has occurred from the reference text is displayed in a form different from those of the other parts. Thus, the user can easily notice a change in the element information.

The search portion 126 may preferentially select utterance text having a shorter period from a point in time when the utterance text has been acquired to a present point in time as the reference text from the utterance text included in the utterance history.

According to the above configuration, when a plurality of pieces of utterance text are candidates for the reference text, newer utterance text is adopted as the reference text. Because the related information about the reference text whose utterance content is similar to current utterance text is displayed, the utterance content conveyed in the utterance text can be easily understood.

The storage portion 140 may store the utterance text and a date and time of acquisition of the utterance text in association with each other in the utterance history and the display processing portion 134 may further output a date and time associated with the reference text.

According to the above configuration, the date and time of acquisition of the reference text is also displayed together with the related information about the reference text. Thus, it is possible to allow the user to understand the utterance content conveyed in the utterance text in consideration of an elapse of time from the date and time of acquisition of the reference text.

The conversation support device 100 may include a speech recognition portion 114 configured to acquire the utterance text by performing a speech recognition process on input speech data.

According to the above configuration, text representing utterance content according to the user's utterance can be acquired as the utterance text. Utterance text including a speech recognition error and related information about the reference text having the same topic as the utterance content are displayed. Thus, the user can easily notice the occurrence of a speech recognition error in the utterance text.

The topic analysis portion 124 may determine the word or the phrase related to the topic conveyed in the utterance text using a topic model representing a word or a phrase related to each topic.

According to the above configuration, the topic analysis portion 124 can determine a word or a phrase related to the topic of the utterance content conveyed in the utterance text in a simple process.

Although one embodiment of the present invention has been described in detail with reference to the drawings, the specific configuration is not limited to the above and various design changes and the like are made without departing from the spirit and scope of the present invention.

For example, the sound collection portion 170, the operation portion 180, and the display portion 190 may not be integrated with the conversation support device 100 or may be separate from the conversation support device 100 if anyone or a combination thereof can make a connection so that various types of data can be transmitted and received wirelessly or by wire.

The speech analysis portion 112 may acquire speech data from the sound collection portion 270 of the terminal device 200 instead of the sound collection portion 170 or together with the sound collection portion 170.

The text acquisition portion 118 may acquire the second text information based on the operation signal input from the operation portion 180 of its own device instead of the operation portion 280 of the terminal device 200.

When the text acquisition portion 118 does not acquire the second text information from the terminal device 200, display screen data may not be transmitted to the terminal device 200.

A shape of the display frame surrounding the display text is not limited to the balloons shown in the examples of FIGS. 4, 5, 7, and 8 and may be any shape such as an ellipse, a rectangle, a parallelogram, or a cloud shape as long as the display text can be accommodated. A horizontal width and a vertical height of the individual display frame may be unified to given values. In this case, an amount of vertical movement when new display text is assigned is equal to the vertical height and a spacing between display frames adjacent to each other. The display text may be displayed on a new line for each utterance without being accommodated and displayed in the display frame. In addition, the positions and sizes of display elements such as buttons and input fields constituting the display screen are arbitrary and some of the above display elements may be omitted. Display elements not shown in the examples of FIGS. 4, 5, 7, and 8 may be included. The wording attached to the display screen or the name of the display element can be arbitrarily set without departing from the spirit and scope of the embodiment of the present application.

What is claimed is:

1. A conversation support device comprising:
a topic analysis portion configured to extract a word or a phrase of a prescribed topic from utterance text representing utterance content;
a search portion configured to search for reference text related to the topic in a storage portion in which an utterance history including previous utterance text is saved; and
a display processing portion configured to output the utterance text and related information about the reference text in association with each other to a display portion.

2. The conversation support device according to claim 1, wherein the display processing portion extracts first element information related to the topic from the utterance text and second element information related to the topic from the reference text and outputs related information about a change to the display portion when the change from the second element information has occurred in the first element information.

3. The conversation support device according to claim 2, wherein the display processing portion determines an omission or a modification of at least a part of the second element information or a partial addition to the first element information as the change.

4. The conversation support device according to claim 3, wherein the display processing portion determines a change in a prescribed numerical value included in the second element information as the change.

5. The conversation support device according to claim 2, wherein the display processing portion causes the display portion to display a part in which the change has occurred in a form different from those of the other parts.

6. The conversation support device according to claim 1, wherein the search portion preferentially selects utterance text having a shorter period from a point in time when the utterance text has been acquired to a present point in time as the reference text from the utterance text included in the utterance history.

7. The conversation support device according to claim 1,
wherein the storage portion stores the utterance text and a date and time of acquisition of the utterance text in association with each other in the utterance history, and
wherein the display processing portion further outputs a date and time associated with the reference text.

8. The conversation support device according to claim 1, comprising a speech recognition portion configured to acquire the utterance text by performing a speech recognition process on input speech data.

9. The conversation support device according to claim 1, wherein the topic analysis portion determines the word or the phrase related to the topic conveyed in the utterance text using a topic model representing a word or a phrase related to each topic.

10. A conversation support system comprising:
the conversation support device according to claim 1; and
a terminal device,
wherein the terminal device includes
an operation portion configured to receive an operation of a user; and
a communication portion configured to transmit the operation to the conversation support device.

11. A computer-readable non-transitory storage medium storing a program for causing a computer to function as the conversation support device according to claim 1.

12. A conversation support method for use in a conversation support device, the conversation support method comprising:
a topic analysis process of extracting a word or a phrase of a prescribed topic from utterance text representing utterance content;
a search process of searching for reference text related to the topic in a storage portion in which an utterance history including previous utterance text is saved; and
a display processing process of outputting the utterance text and related information about the reference text in association with each other to a display portion.
